(19) United States
(12) Patent Application Publication
(10) Pub. No.: US 2021/0208867 A1
(43) Pub. Date: Jul. 8, 2021

(54) FIRMWARE UPDATE BY CENTRAL CONTROL MODULE OF A CHARGING STATION

(71) Applicants: Edgar Brodde, Dortmund (DE); Stephan Cater, Dortmund (DE)

(72) Inventors: Edgar Brodde, Dortmund (DE); Stephan Cater, Dortmund (DE)

(73) Assignee: innogy SE, Essen (DE)

(21) Appl. No.: 17/211,700

(22) Filed: Mar. 24, 2021

Related U.S. Application Data
(63) Continuation of application No. PCT/EP2019/074928, filed on Sep. 18, 2019.

(30) Foreign Application Priority Data
Sep. 25, 2018 (DE) 102018123613.1

(51) Int. Cl. G06F 8/654; B60L 53/68; H02J 7/00

(52) U.S. Cl. CPC G06F 8/654; B60L 53/68; H02J 2310/48; B60L 2270/40; H02J 7/00032

(57) ABSTRACT

A charging station for charging electrically operated vehicles in particular a charging pole has a central control module and at least one secondary module. The secondary module has its own firmware memory and is connected to the central control module via a communication link. The central control module is configured to obtain a firmware update for the at least one secondary module and to cause installation of the obtained firmware update in the firmware memory of the secondary module. The invention further relates to a method for controlling a charging station carried out on a central control module of a charging station, in which a firmware update for an secondary module of the charging station is obtained, in particular received via communication link to an external server, and in which the installation of the obtained firmware update in the firmware memory of the secondary module is caused.

### CROSS-REFERENCE TO RELATED PATENT APPLICATIONS

This patent application is a continuation of International Application No. PCT/EP2019/074928, filed on Sep. 18, 2019, which claims the benefit of priority to German Patent Application No. 10 2018 123 613.1, filed Sep. 25, 2018, the entire teachings and disclosures of both applications are incorporated herein by reference thereto.

### FIELD OF INVENTION

The invention relates to a charging station for charging electrically operated vehicles, in particular a charging pole, having a central control module and having at least one secondary module, the secondary module having its own firmware memory and being connected to the central control module via a communication link. The invention furthermore relates to a method for controlling a charging station, carried out on a central control module of a charging station, in particular of the aforementioned charging station.

### BACKGROUND OF INVENTION

A charging station comprises a range of different electronic modules, for example a charging process module for controlling a charging process, a measurement module for measuring the charging current during the charging process, a display module for controlling a display for the user communication, and a central control module for coordinating the individual modules.

The individual modules of a charging station typically each have their own firmware memory with their own firmwares for controlling the respective module. Since the individual modules are often produced by different manufacturers and are subject to independent development cycles, respective firmware updates for the individual modules, which are not necessarily matched to one another, are available at different times. The installation of the firmware updates may also differ from module to module, since the methods or protocols used are manufacturer-specific.

At present, firmware updates are carried out on the individual modules by a service employee on site, since automated update installation is generally not possible.

### BRIEF SUMMARY

Against this background, the object of the present invention is to provide a charging station and a method for controlling a charging station, with which firmware updates can be carried out more easily.

For a charging station for charging electrically operated vehicles, in particular a charging pole, having a central control module and having at least one secondary module, the secondary module having its own firmware memory and being connected to the central control module via a communication link, this object is achieved according to the invention in that the central control module is configured to obtain a firmware update for the at least one secondary module and to cause installation of the obtained firmware update in the firmware memory of the secondary module.

In this way, an update of the firmware of a secondary module can be carried out by the central control module and thereby automated, so that it is unnecessary for the update to be carried out by a service engineer on site.

The charging station is used for charging electrically operated vehicles, and correspondingly comprises the components required therefor. In particular, the charging station may comprise a housing, a network connection to the local electricity supply network, a current transformer for transforming the current provided by the electricity supply network into the charging current to be provided, a socket for plugging in a charging cable, or a charging cable mounted directly on the charging station, a user interface, for example a touchscreen, and/or a measuring instrument for determining the charging current.

The charging station comprises a central control module. The central control module may, in particular, be a main control module of the charging station, on which software for operating the charging pole is executed during operation and which is configured to drive further components of the charging station. The central control module preferably has its own firmware memory with its own firmware for operating the central control module.

The charging station furthermore comprises at least one secondary module having its own firmware memory, for example a firmware flash memory. The secondary module may in particular be a controller for the network connection and/or the current transformer, the controller of the user interface or the controller of the measuring instrument.

The central control module is configured to cause installation of the obtained firmware update in the firmware memory of the secondary module. To this end, in particular, a communication link may be provided between the central control module and an interface of the secondary module for installing firmware updates in the firmware memory. As an alternative, a communication link may also be provided between the central control module and a communication interface of the secondary module, via which the central control module transmits the obtained firmware update to the secondary module and can instruct the secondary module to carry out the installation of the firmware update in the firmware memory.

The central control module is furthermore preferably configured to initiate a restart of the secondary module after the installation of the firmware update, so that the new firmware is loaded.

The aforementioned object is furthermore achieved according to the invention by a method for controlling a charging station, carried out on a central control module of a charging station, in particular of the aforementioned charging station, wherein a firmware update for a secondary module of the charging station is obtained, in particular received via a communication link to an external server, and wherein the installation of the obtained firmware update in the firmware memory of the secondary module is caused.

Various embodiments of the charging station and of the method will be described below, the individual embodiments respectively applying independently of one another both for the charging station and for the method. The embodiments may furthermore be combined with one another.

In a first embodiment, the central control module is configured in the form of a central control circuit board, and/or the at least one secondary module is configured in the form of a secondary circuit board having a firmware memory. The modules used for charging stations are often in the form of circuit boards, the electronic components of the module being connected together on a circuit board. In the case of such a circuit board, the firmware is typically stored in a memory chip, for example in a flash memory. Parts of the firmware may also be stored in an EEPROM. In particular, it is possible that only parts of the firmware, for example the parts of the firmware which are stored in a flash memory, are overwritten during an update of the firmware.

In a further embodiment, the charging station comprises a plurality of secondary modules, each having its own firmware memory, the secondary modules being connected to the central control module via communication links, and the central control module is configured to obtain a respective firmware update for the individual secondary modules and to cause installation of the respective obtained firmware update in the firmware memory of the respective secondary module. In this way, the updating of the respective firmware of a plurality of secondary modules may be controlled centrally by the central control module. This greatly facilitates the updating of firmwares of the charging station. The secondary modules may be connected to the central control module in a star configuration, via a data bus and/or in series. For the updating of the firmwares, the central control module preferably has a respective communication link to an interface of a respective secondary module for installing a firmware update or for transmitting a firmware update and initiating the installation of this firmware update.

The communication links between the central control module and the individual secondary modules may be different types of links, depending on the type of secondary module, for example via an I²C data bus or via an RS-422 interface.

In a further embodiment, a communication interface is provided for a communication link between the central control module and an external server, and the central control module is configured to receive a firmware update for a secondary module via the communication link. In this way, the charging station is capable of receiving firmware updates for the individual modules of the charging station from an external server. This allows external and central provision of firmware updates, for example on a server from which the correspondingly configured charging stations may receive the current firmware updates of the individual modules.

The communication interface may be configured for a wired communication link, for example as a network interface to a LAN or WAN network. Furthermore, the communication interface may also be configured for a wireless communication link, for example to a local WLAN or to a mobile communication network. For example, the communication interface may be configured to establish a communication link to an external server via the Internet or via another communication network. The communication link may also be a peer-to-peer link.

In a further embodiment, the central control module is configured to store the current firmware status of the at least one secondary module in a memory of the central control module. In this way, the information relating to the current firmware status or statuses of the secondary module or modules of the charging station is available in the central control module, so that the central control module can check the availability of updates for the secondary module or modules.

The firmware status may in particular contain the firmware version number and/or a timestamp, for example the time of the last installation of a firmware update. The current firmware status of a secondary module, stored in a memory of the central control module, may in particular be updated during a firmware update caused in the secondary module by the central control module. In this way, a change of a firmware status is automatically also logged in the central control module. As an alternative or in addition, the firmware status of a secondary module may also be determined by retrieval via a communication link to the secondary module and stored in the central control module. In this way, firmware status changes due to replacement of modules or due to manual installation of a firmware update by a service engineer on site may also be detected by the central control module.

In a further embodiment, the central control module is configured to check the availability of a firmware update for a secondary module via a communication link to an external server, in particular by comparing an available firmware status obtained via the communication link with a current firmware status of a secondary module. In a corresponding embodiment of the method, the availability of a firmware update for a secondary module of the charging station is checked via a communication link to an external server, wherein in particular an available firmware status is obtained via the communication link and compared with a current firmware status of the secondary module. In this way, the central control unit may automatically establish when a new firmware status is available for a module of the charging station.

For example, the central control module may be configured to check the availability of a firmware update for a secondary module at predetermined times or at regular time intervals. In this way, the central control module automatically keeps the charging station at a current firmware status so that, for example, security vulnerabilities due to installing a firmware update can be resolved more rapidly.

At a check whether a new firmware update is available for a secondary module, a comparison of an available firmware status with the current firmware status of a secondary module is preferably carried out. In particular, the firmware version number of an available firmware may be compared with the current firmware version number of the firmware stored in a secondary module. To this end, the firmware status of the secondary module, in particular the firmware version number, is preferably stored in a memory of the central control module.

The comparison is preferably carried out in the central control module. As an alternative, the central control module may also be configured to send the current firmware status of a secondary module to the server via a communication link and to receive a server response relating to the availability of a firmware update for this firmware status. The check may therefore also be carried out on the server.

In a further embodiment, the central control module is configured to carry out the obtaining of an available firmware update for a secondary module or the causing of the installation of the available firmware update in the firmware memory of the secondary module as a function of the result of a firmware compatibility check. In a corresponding embodiment of the method, the obtaining of an available firmware update for a secondary module or the causing of the installation of the available firmware update in the firmware memory of the secondary module is carried out as a function of the result of a firmware compatibility check. It has been found that it may be problematic to install a firmware update of a secondary module immediately when it is available, since the new firmware version of the secondary module may not be compatible with the current firmware statuses of the other modules of the charging station. By a firmware update being obtained and/or installed as a function of the result of a firmware compatibility check, it is possible to ensure that a set of mutually compatible firmware statuses is stored in the modules of a charging station.

The firmware compatibility check is preferably carried out in the central control module. To this end, the central control unit is preferably configured to receive a compatibility data set relating to the compatibility of the firmware update available on the external server for the one secondary module with firmware statuses of other modules, and to check the compatibility of the available firmware updates as a function of the compatibility data set and the firmware statuses of the other modules.

As an alternative, the firmware compatibility check may also take place on the external server. To this end, the central control module is configured in particular to send the firmware statuses of the other modules to the external server via the communication link and to obtain a server response relating to the compatibility of the available firmware version for the one secondary module with the firmware statuses of the other modules.

In a further embodiment, the firmware compatibility check comprises a check of the compatibility of the firmware update available for the one secondary module with the firmware status of another secondary module or of the central control module. In a corresponding embodiment of the method, the compatibility of the firmware update available for the one secondary module with the firmware status of another secondary module or of the central control module is checked during the firmware compatibility check. In this way, it is possible to establish whether an available firmware update is compatible with the current firmware status of another module.

In a further embodiment, in addition or as an alternative, the firmware compatibility check comprises a check of the compatibility of the firmware update available for the one secondary module with a firmware update available for another secondary module or for the central control module. In a corresponding embodiment of the method, in addition or as an alternative, the compatibility of the firmware update available for the one secondary module with a firmware update available for another secondary module or for the central control module is checked during the firmware compatibility check. In this way, it is possible to establish whether the available firmware update is compatible with an available firmware update of another module.

If, for example, it is established that a firmware update available for a first secondary module is not compatible with the current firmware status of a second secondary module but is compatible with a firmware update now available for the second secondary module, compatibility of the firmware statuses may thus possibly be achieved by updating the firmware of both secondary modules. In this way, the central control module may not only cause the installation of firmware updates of individual secondary modules but also coordinate the installation of firmware updates of a plurality of secondary modules in such a way that a set of compatible firmwares is installed in the individual modules.

### BRIEF DESCRIPTION OF THE DRAWINGS

Further advantages and features of the charging station and of the method emerge from the following description of exemplary embodiments, reference being made to the appended drawing.

In the drawing:

FIG. 1 shows an exemplary embodiment of the charging station in the form of a charging pole in a schematic representation,

FIGS. 2-3 show alternative exemplary embodiments of the charging station in a schematic representation,

FIG. 4 shows the central control module of the charging station of FIG. 1 in a schematic representation,

FIG. 5 shows a secondary module of the charging station of FIG. 1 in a schematic representation,

FIG. 6 shows an exemplary embodiment of the method for controlling a charging station as a flowchart,

FIG. 7a-b show examples of available firmware statuses,

FIG. 8 shows an example of stored firmware statuses, and

FIG. 9a-c show examples of compatibility data sets.

### DETAILED DESCRIPTION

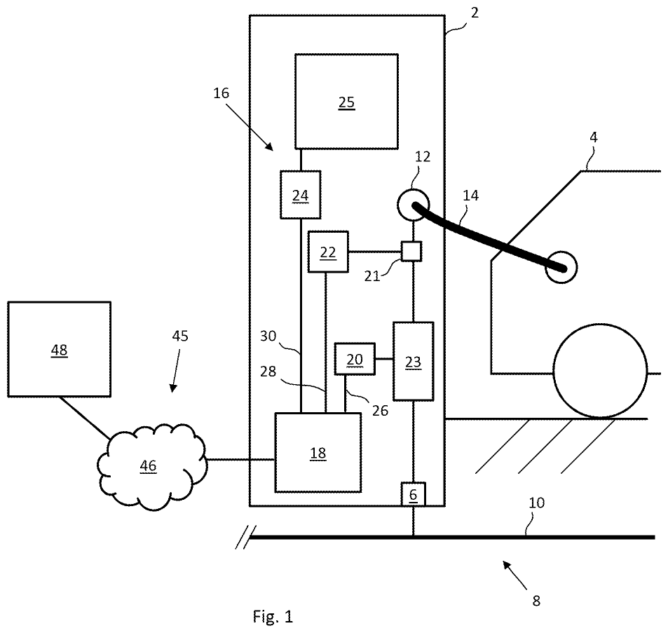

FIG. 1 shows a charging station 2 in the form of a charging pole for providing electrical power for charging an electrically operable vehicle 4. To this end, the charging pole 2 comprises a current connection 6 on the network side, to which, in order to supply electricity, the charging station 2 can be connected to a local distribution network 8, an underground cable 10 of which is schematically represented in FIG. 1.

In order to charge the vehicle 4, the charging pole 2 is configured to output a charging current through a charging socket 12, to which the vehicle 4 to be charged can be connected by means of a charging cable 14. As an alternative, the charging current may also be output directly through a charging cable connected to the charging pole 2 in a fixed fashion. In this case, the charging socket 12 can be dispensed with.

In order to control the charging station 2, particularly in order to control a charging process, the charging station 2 comprises charging station electronics 16. The charging station electronics 16 comprise a central control module 18 and a plurality of secondary modules connected thereto, of which three secondary modules 20, 22 and 24 are represented in FIG. 1 by way of example.

The central control module 18 may, in particular, be a central control circuit board. During operation, software for operating the charging station 2, in particular for carrying out and for monitoring charging processes via the charging socket 12, runs on the central control module 18.

The individual secondary modules 20, 22, 24 may likewise be configured in the form of respective secondary circuit boards. Preferably, the individual secondary modules are configured to control particular functions of the charging station. The secondary module 20 may for example be a control unit for controlling a current transformer 21, which carries out the conversion of the current provided by means of the current connection 6 into the charging current output through the charging socket 12. The secondary module 22 may for example be a control unit for a measurement unit, which measures the current output through the charging socket 12 during a charging process. The secondary module 24 may for example be a control unit for a user interface, for example a touchscreen 25, by means of which a user may log in at the charging station, initiate the start of a charging process and/or carry out a payment process, by corresponding user inputs.

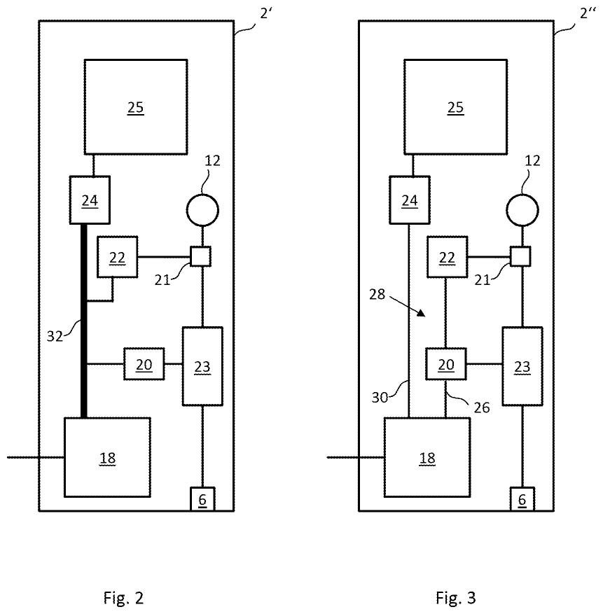

The individual secondary modules 20, 22, 24 are connected to the central control module 18 via corresponding communication links 26, 28, 30. The communication links may, as represented in FIG. 1, be formed directly between the respective secondary modules and the central control module 18. As an alternative, as in the case of the charging station 2′ in FIG. 2, it is conceivable to achieve the communication links between the individual secondary modules 20, 22, 24 and the central control module 18, via a central data bus link 32, to which the individual secondary modules are connected. A further possibility for connecting the secondary modules 20, 22, 24 to the central control module 18 is shown in FIG. 3 for the charging station 2″ illustrated therein. In this example, the secondary module 22 is connected to the central control module 18 via the secondary module 20, i.e. the secondary modules are partly connected in series. Furthermore, combinations of the aforementioned connection variants are likewise possible.

A respective direct communication link between the central control module 18 and the individual secondary modules 20, 22, 24 (cf. FIG. 1) is preferred, since this design allows direct driving of the secondary modules 20, 22, 24 by the central control module 18 and makes various communication links or protocols possible (for example I²C data bus, RS-422, etc.).

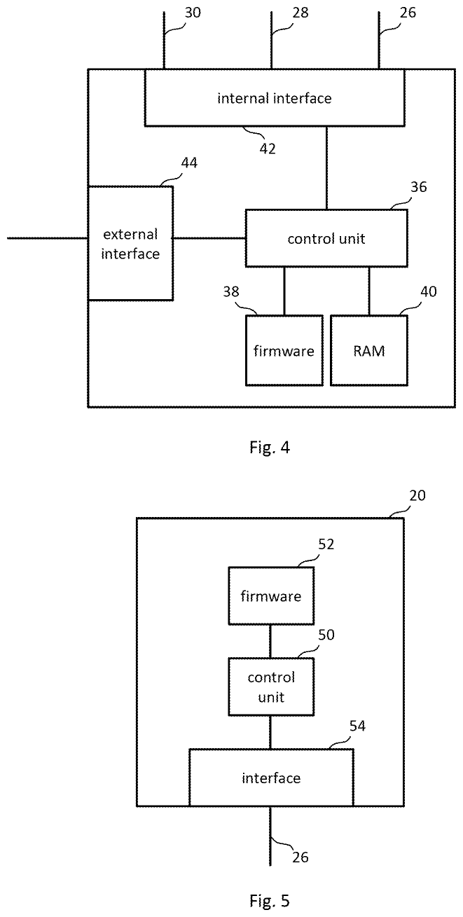

An exemplary structure of the control module 18 will be explained below with the aid of FIG. 4.

The central control module 18 comprises a control unit 36, in particular a microprocessor, a firmware memory 38 in the form of a flash memory, and a memory 40 in the form of a RAM chip, which are respectively connected to the control unit 36. An internal interface 42 is furthermore provided for the communication links of the central control module 18 to the secondary modules 20, 22, 24. In FIG. 4, the internal interface 42 comprises three individual interfaces for the communication links 26, 28, 30, which may be configured for different transmission methods and protocols, depending on the interface of the secondary module in question (for example for an I²C bus or an RS-422 interface). As an alternative, a plurality or all of the individual interfaces may also be combined to form a bus interface (for example for an I²C bus), as in the case of the charging station 2′ represented in FIG. 2.

The central control module 18 furthermore comprises an external interface 44, which is configured to establish a communication link 45 to an external server 48, for example via an external network 46 such as the Internet, to which the external server 48 is connected. The external interface 44 may, for example, be a LAN interface or an Internet connection.

FIG. 5 schematically shows a possible structure of a secondary module using the example of the secondary module 20. The secondary module 20 has its own control unit 50, in particular a microprocessor, and its own firmware memory 52 connected thereto. The secondary module furthermore comprises an interface 54 for the communication link 26 to the central control module 18. The secondary module 20 may also comprise further components which are required for the functionality of the secondary module 20, in particular an interface for connection to the current transformer 21 if the secondary module 20 is provided for controlling the latter. These further components are not shown in FIG. 5 for the sake of clarity.

The central control module 18 and the individual secondary modules 20, 22, 24 for controlling various functions of the charging station 2 are typically produced by different manufacturers. The manufacturers respectively equip the modules produced by them with their own firmware, which typically contain instructions for basic functions of the modules, in the factory. In order to keep the firmware of the individual modules up to date, firmware updates have previously been installed in the individual modules on site by a service engineer.

In order to make this elaborate procedure obsolete and to be able to install firmware updates in the modules of a charging stations regardless of the availability of service engineers, the central control module 18 of the charging station 2 is in the present case configured to obtain firmware updates for the respective secondary modules 20, 22 and 24 via the external interface 44 and cause installation of the respective firmware update in the respective firmware memory (for example firmware memory 52 in the case of the secondary module 20). In this way, the conduct of firmware updates may be achieved centrally via the central control module 18 of the charging station 2.

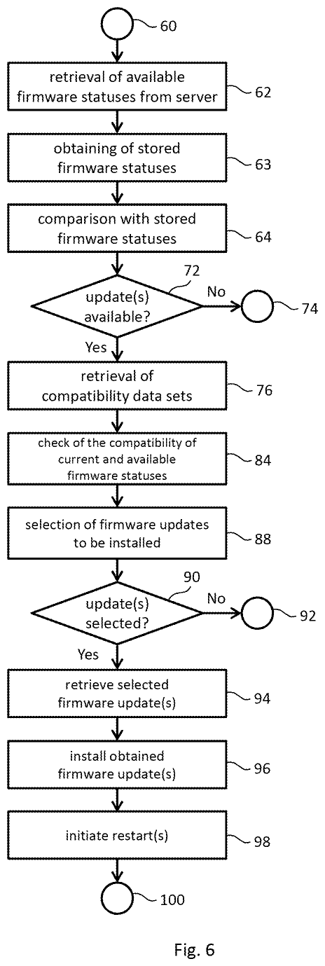

To this end, a computer program having instructions, the execution of which in the control unit 36 causes a method for controlling the charging station as described below with the aid of FIG. 6 being carried out, is stored in a memory of the central control module 18, particularly in the firmware memory 38, preferably as part of the firmware stored therein, or in the memory 40.

FIG. 6 shows an exemplary embodiment of the control of the charging station 2 as a workflow. The method is carried out in the central control module 18 of the charging station 2.

The method begins with the program being invoked at the start point 60. This invoking may for example be initiated at predetermined times, in particular at regular time intervals, or at a point in time which is transmitted from the external server 48 via the network 46 to the central control module.

In the first step 62 of the method, the firmware statuses available on the server 48 for the central control model 18 and the secondary modules 20, 22 and 24 are retrieved. To this end, the central control module 18 is configured to send the corresponding request via the external interface 44 and receive a response of the server 48 relating to the available firmware statuses.

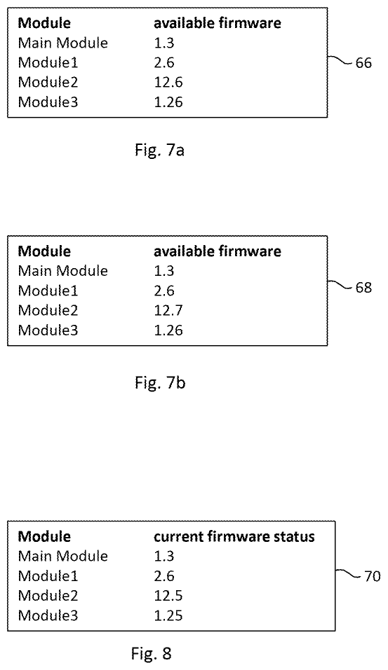

FIG. 7a shows a possible response 66 of the server 48 to the request of the central control module 18 relating to the currently available firmware updates. In the table, the respective module (“Main Module”=central control module 18, “Module1”=secondary module 20, “Module2”=secondary module 22, “Module3”=secondary module 24) is indicated in the left column and the version of the respectively associated firmware update available on the server 48 is indicated in the right column. The respectively indicated firmware versions of the individual modules typically relate to different firmwares of different manufacturers, since the individual modules of a charging station are typically of different types and have generally been produced by different manufacturers. According to the server response in FIG. 7a, for example, the firmware version 1.3 is available for the firmware of the main module, the firmware version 2.6 is available for “Module1” (secondary module 20), etc.

FIG. 7b shows another possible response 68 of the server 48 at a later point in time, at which the firmware version 2.7 is already available for “Module1”.

In step 63, the central control module obtains the current firmware statuses of the central control module 18 and of the respective secondary modules 20, 22, 24. To this end, the central control module 18 may be configured to send respective requests to the individual secondary modules 20, 22, 24 via the communication links 26, 28, 30 and receive the respective current firmware statuses of the individual modules. As an alternative, the current firmware statuses of the individual secondary modules 20, 22, 24 may also be stored in a memory, particularly in the memory 40, of the central control module 18, for example in the form of a table as represented by way of example in FIG. 8.

FIG. 8 shows—in a similar way to the representation in FIG. 7a-b—the firmware versions installed in the respective firmware memories of the respective modules (for example firmware memory 38 of the central control module, firmware memory 52 of the secondary module 20), i.e. the current firmware statuses.

In step 64, the central control unit compares the available firmware statuses received from the server 48 (Table 68 or 70) with the current firmware statuses in the respective firmware memories (Table 66). The comparison of the firmware statuses stored according to FIG. 8 with the firmware statuses available according to FIG. 7a shows, for example, that firmware updates are available for the secondary modules 22, 24 (“Module2”, “Module3”), while the most recent firmwares are already installed for the central control module 18 (“Main Module”) and the secondary module 20 (“Module1”).

In step 72, a case differentiation is made according to whether or not one or more recent firmware update(s) are available. If no more recent updates are available, the method ends at the end point 74. If at least one more recent update is available, the method continues with step 76.

It has been established that it is not expedient to install each firmware update available for a module immediately, since typically not all firmware versions of the individual modules of a charging station 2 are mutually compatible.

In order to ensure compatibility of the individual firmwares installed in the modules of the charging station 2, associated compatibility data sets for the available firmware updates are therefore retrieved in step 76. To this end, the central control module 18 sends corresponding requests to the server 48 via the external interface 44 and receives the transmitted compatibility data sets. As an alternative, the compatibility data sets may also be received directly in step 62 together with the dataset relating to the available firmware statuses.

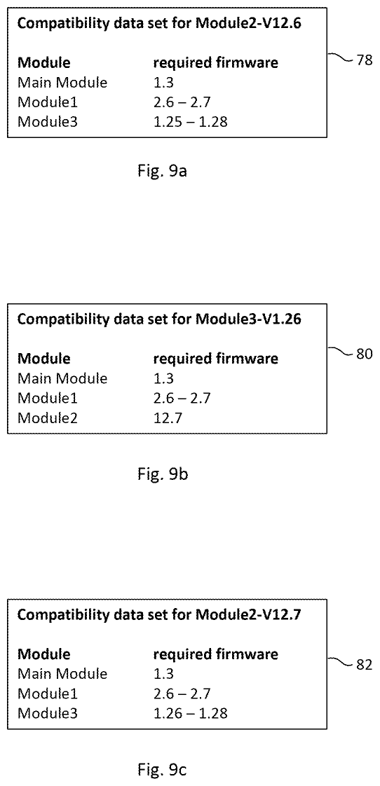

FIGS. 9a-c show examples of compatibility data sets. FIG. 9a-b show a respective compatibility data set 78, 80 for the firmware updates available according to the table in FIG. 7a for the secondary modules 22, 24 (version “12.6” for “Module2” and version “1.26” for “Module3”). FIG. 9c shows a compatibility data set 82 for the further firmware update available at a later point in time according to the table in FIG. 7b for the secondary module 22 (version “12.7” for “Module2”).

The compatibility data sets 78, 80 and 82 for the firmware updates of the individual modules are represented in FIG. 9a-c as a table which lists the respective other modules of the charging station 2 in the left column and in the right column the associated firmware statuses of these other modules, with which the relevant firmware update is compatible. Thus, for the installation of firmware version “12.6” for the secondary module 22 (“Module2”), it is necessary for the firmware version “1.3” to be installed in the central control module 18, for a firmware version from “2.6” to “2.7” to be installed in the secondary module 20 and for a firmware version from “1.25” to “1.28” to be installed in the secondary module 24.

In the next step 84 of the method, the check of the compatibility of the firmware updates available for the individual modules with the current and available firmware statuses of the respective other modules is carried out with the aid of the received compatibility data sets.

In the case of the available firmware statuses according to FIG. 7a and the current firmware statuses according to FIG. 8, this check reveals that the update to version “12.6” available for “Module2” is compatible, according to the compatibility data set 78 (FIG. 8a), with the stored and available firmware statuses (FIG. 8) of the other modules. Conversely, the update to version “1.26” available for “Module3” is compatible, according to the compatibility data set 80 (FIG. 8b), neither with the stored firmware status “12.5” for “Module2” nor with the firmware update “12.6” available for this module.

In the case of the available firmware statuses according to FIG. 7b and the stored firmware statuses according to FIG. 8, this check reveals that both the firmware update to version “12.7” available for “Module2” (compatibility data set 82 in FIG. 8c) and the update to version “1.26” available for “Module3” (compatibility data set 80 in FIG. 8b) are compatible with the current and available firmware statuses of the other modules.

In step 88, the firmware updates to be installed are selected on the basis of the check previously carried out. The firmware updates which are compatible together with the current firmware statuses, or the further firmware updates to be installed, of the other modules are selected so that a set of mutually compatible firmware statuses is obtained.

In the case of FIG. 7a, only the firmware update to version “12.6” for “Module2” would be selected. In the case of FIG. 7b, both the firmware update to version “12.7” for “Module2” and the firmware update to version “1.26” available for “Module3” would be selected.

During the subsequent case differentiation 90, the method ends at the end point 92 if no firmware updates have been selected for installation. Otherwise, the selected firmware updates are received from the server 48 in the next step 94. To this end, the central control module 18 sends corresponding requests via the external interface 44 and receives the firmware updates sent by the server 48.

The obtained firmware updates are installed in the corresponding modules in step 96. To this end, the central control module 18 transmits the firmware update for a secondary module via the corresponding communication link (for example communication link 26 for the secondary module 20) to the respective secondary module so that the firmware update is installed in the firmware memory of the corresponding secondary module. After installation of the respectively selected and received firmware updates has been carried out, the central control module initiates a restart of the respective secondary modules in step 98 by a corresponding instruction being sent via the associated communication link. The method then ends at the end point 100.

With the method described with the aid of FIG. 6, firmware updates of the individual secondary modules 20, 22, 24 and of the central control module 18 can be carried out centrally by the central control module 18. In this way manual installation of firmware updates in the individual modules of a charging station 2 by a service engineer can be dispensed with. Furthermore, the method automatically makes sure that a set of compatible firmware versions is installed in the individual modules, so that correct operation of the charging station 2 is ensured.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A charging station for charging electrically operated vehicles, in particular charging pole,
having a central control module and having at least one secondary module, the secondary module having its own firmware memory and being connected to the central control module via a communication link,
wherein,
the central control module is configured to obtain a firmware update for the at least one secondary module and to cause installation of the obtained firmware update in the firmware memory of the secondary module.

2. The charging station according to claim 1,
wherein the central control module is configured in the form of a central control circuit board, and/or in that the at least one secondary module is configured in the form of a secondary circuit board having a firmware memory.

3. The charging station according to claim 1,
wherein the charging station comprises a plurality of secondary modules, each having its own firmware memory, the secondary modules being connected to the central control module via communication links and in that the central control unit is configured to obtain a respective firmware update for the individual secondary modules and to cause installation of the respective obtained firmware update in the firmware memory of the respective secondary module.

4. The charging station according to claim 1,
wherein the communication interface is provided for a communication link between the central control module and an external server, and the central control module is configured to receive a firmware update for an secondary module via the communication link.

5. The charging station according to claim 1,
wherein the central control module is configured to store the current firmware status of the at least one secondary module in a memory of the central control module.

6. The charging station according to claim 1,
wherein the central control module is configured to check the availability of a firmware update for an secondary module via a communication link to an external server, in particular by comparing an available firmware status obtained via the communication link with a current firmware status of a secondary module.

7. The charging station according to claim 1,
wherein the central control module is configured to carry out the obtaining of an available firmware update for a secondary module or the causing of the installation of the available firmware update in the firmware memory of the secondary module as a function of the result of a firmware compatibility check.

8. The charging station according to claim 7,
wherein the firmware compatibility check comprises a check of the compatibility of the firmware update available for the one secondary module with the firmware status of another secondary module or of the central control module.

9. The charging station according to claim 7,
wherein the firmware compatibility check comprises a check of the compatibility of the firmware update available for the one secondary module with a firmware update available for another secondary module or for the central control module.

10. A method for controlling a charging station, carried out on a central control module of a charging station, in particular of a charging station according to claim 1,
in which a firmware update for a secondary module of the charging station is obtained, in particular received via a communication link to an external server, and
in which the installation of the obtained firmware update in the firmware memory of the secondary module is caused.

11. The method according to claim 10,
wherein the availability of a firmware update for a secondary module of the charging station is checked via a communication link with an external server, wherein in particular an available firmware status is obtained via the communication link and compared with a current firmware status of the secondary module.

12. The method according to claim 10,
wherein the obtaining of an available firmware update for an secondary module or the causing of the installation of the available firmware update in the firmware memory of the secondary module is carried out as a function of the result of a firmware compatibility check.

13. The method according to claim 10,
wherein the compatibility of the firmware update available for the one secondary module with the firmware status of another secondary module or of the central control module is checked during the firmware compatibility check.

14. The method according to claim 10,
wherein the compatibility of the firmware update available for the one secondary module with a firmware update available for another secondary module or for the central control module is checked during the firmware compatibility check.
